(19) United States
(12) Patent Application Publication
(10) Pub. No.: US 2005/0084582 A1
(43) Pub. Date: Apr. 21, 2005

(54) Sweetener combination for sweetening preserved fruit

(76) Inventor: Katrin Saelzer, Grosskrotzenburg (DE)

Correspondence Address: PROPAT, L.L.C., 425-C SOUTH SHARON AMITY ROAD, CHARLOTTE, NC, 28211-2841, US

(21) Appl. No.: 10/924,160

(22) Filed: Aug. 23, 2004

(30) Foreign Application Priority Data
Oct. 16, 2003 (DE) 103 48 723.9

(51) Int. Cl. A23L 1/236

(52) U.S. Cl. 426/548

(57) ABSTRACT

The invention relates to a sweetener combination of acesulfame-K and sucralose in a weight ratio of at least 75/25 for sweetening preserved fruit. The invention further relates to a process for the at least partial replacement of sucrose (sugar) in preserved fruit.

### CROSS REFERENCE TO RELATED APPLICATION

This application claims priority through its parent application, German Patent Application 103 48 723.9 filed Oct. 16, 2003, hereby incorporated by reference herein in its entirety.

### FIELD OF THE INVENTION

The invention relates to a sweetener combination of acesulfame-K and sucralose in a weight ratio of at least 75/25 for sweetening preserved fruit. In addition, the invention relates to a process for at least partially replacing sucrose (sugar) in preserved fruit.

### BACKGROUND OF THE INVENTION

Preserved fruit on the market usually comprise between 10 and 25% by weight of sugar, but higher concentrations up to above 30% by weight can occasionally be reached. The sugar in preserved fruit serves primarily for sweetening, but also to improve the aroma and fruitiness.

Because of the increased health consciousness of consumers, which is also reflected in their diet, there are efforts, firstly, directed toward increased consumption of fruit and vegetables, and secondly directed toward decreasing consumption of added sugar to reduce calorie intake.

The sometimes very high sugar content of fruit in preserves is therefore perceived disadvantageous by consumers, which has an adverse effect on consumption and thus the market of such products.

In addition to the high nutritional benefit of preserved fruit, for consumers the good taste also plays a major role. A product which does not meet the taste expectations of the consumers will not be accepted either. Further decision criteria are the ready handling and sufficient storage stability of the products. This is approximately 3-4 years in the case of commercially conventional preserved fruit.

The market for sugar-free and thus reduced-calorie preserved fruit is very limited to date, since either the taste quality or storage stability in the end product does not conform to the requirements of consumers.

Sweeteners for preserved fruit used to date are saccharin and cyclamate as individual sweetener or in combination, where both systems do not correspond to the taste requirements of consumers with respect to sweetness intensity and quality of the sweetness profile and fruitiness. A mixture of acesulfame K and aspartame is used for producing preserved fruit but sufficiently long-term storage stability of the sweetness is not provided.

C. A. West [U.S. Pat. No. 2,536,970] in 1951 described the reduction of the unwanted off-taste and after-taste of saccharin-sweetened preserved fruit by combinations with pectin. H. W. Walker [U.S. Pat. No. 2,608,489] stated in 1952 that it is possible to enhance the taste of the sweet fruit products by a combination of saccharin with the sugar alcohol sorbitol and/or carboxymethylcellulose. In this case sorbitol serves to enhance the sweet taste, carboxymethylcellulose is said to contribute to optimization of mouth feel.

None of these possibilities were actually used in the current market for preserved fruit, since the taste qualities of such products clearly do not meet consumer expectation. J. B. Gordon [U.S. Pat. No. 2,629,655], in the case of the described mixtures of saccharin with pectin or sorbitol, still observed a metallic off-taste which adversely affected the overall impression of the product. As an alternative, a mixture of saccharin and cyclamate is proposed for sweetening preserved fruit, which mixture, with respect to sweetness, is closer to the standard, sugar, than preserved fruit containing saccharin or one of the mixtures described above.

Anderson et al. [Journal of the American Dietetic Association, August 1953 (29), 770-773], however, describes differences between preserved fruit sweetened with mixtures of saccharin and/or cyclamate compared with sugar and fruit in aqueous solution. For virtually all fruits, for example raspberries, sweet cherries, pears or rhubarb, the sugared samples were preferred. All sugar-free sweetening systems were only preferred to fruit in water.

It is known from various more recent studies in sugar-free and reduced-sugar drinks that some sweetening systems have a particularly sugar-like sweet taste and particularly show certain aromas to advantage [Meyer, World of Food Ingredients, December 2000, 42-44], [Meyer, Soft Drink International, September 2001]. It was found that, especially, combinations of acesulfame-K and aspartame in mixing ratios of 30/70 to 50/50 give very good results with respect to the quality of sweetness and support of the aroma.

For preserved fruit which are sweetened with aspartame alone or in a blend, with, for example, acesulfame-K, however, a storage life of only 12 to 18 months is possible [G. Frei, Nutrasweet® and heat processing-product opportunities, 1990, anon., 155-160], but the shelf life of these products should usually be 3-4 years. For use in preserved fruit, stability of the sweetness of aspartame-containing mixtures after heating and storage over several years is therefore insufficient.

In contrast, it is known that the sweeteners acesulfame-K and also sucralose are stable under the abovementioned temperature conditions [Alternative Sweeteners, Editors Lyn O'Brien Nabors, Robert C. Gelardi, Calorie Control Council Atlanta, 2nd Edition 1991].

Furthermore it is known from the abovementioned studies that mixtures of acesulfame-K and sucralose in drinks in sweetness ratios of about 20/80 or 30/70, which is equivalent to a weight fraction of 45/65 or 55/45, have a very sugar-like sweetness and a pleasant sweetness profile as given, for example, by combinations in the sweetness ratio acesulfame-K/sucralose around 50/50, which is equivalent to the weight ratio of 75/25. Other recommendations [Splenda Inc 2001, Splenda Brand Sweetener in soft drinks, product booklet] describe, as optimum-tasting mixing ratios for acesulfame-K and sucralose in drinks and foods, mixtures in which the weight fraction of the sucralose in the mixture is high, that is to say the ratio of the two sweeteners to one another is shifted toward sucralose.

Comparable concepts for preserved fruit which in addition meet the high storage time of preserved fruit, are unknown, in contrast.

### SUMMARY OF THE INVENTION

It is therefore an object of the present invention to provide a sweetener design which meets all of the following conditions:

1) sugar reduction and thus calorie reduction compared with conventionally sugared preserved fruit,

2) stability of the sweetness even after heating and storage of the preserve over several years.

3) taste improvement of previous sugar-free preserved fruit toward a very sugar-like sweetness and good support of the fruit aroma.

This object is achieved by using acesulfame-K in combination with sucralose for sweetening reduced-sugar or sugar-free preserved fruit.

### BRIEF DESCRIPTION OF THE DRAWINGS

FIG. 1 is a graphical illustration of the results of a triangle test of acesulfame-K/sucralose versus sucrose.

### DETAILED DESCRIPTION OF THE INVENTION

Thus it has surprisingly been found that, in preserved fruit, mixtures of acesulfame-K and sucralose, especially in a sweetness ratio of at least 50/50, this is equivalent to weight ratios of acesulfame-K to sucralose of at least 75/25, give a preferred sweetness profile. This is particularly surprising to the extent that in previous sugar-free drinks and food mixtures of acesulfame-K and sucralose having a high sucralose content (greater than 50% sweetness fraction or greater than 25% by weight) always cause a particularly sugar-like sweet taste. In preserved fruit, however, better-tasting products are obtained when the familiar ratios are reversed and the sweetness contribution of acesulfame-K in the sweetener mixture predominates.

It has further been found that preserved fruit which are sweetened with inventive mixtures of acesulfame K and sucralose, owing to the more pleasant sweetness and the fuller fruit aroma are preferred to previously customary preserved fruit sweetened with saccharin and cyclamate.

The inventive use of sweetener mixtures can be employed, for example, in the form that the sweeteners or the sweetener mixture are added directly to the preserve or by using solutions of the sweeteners or sweetener mixture as make-up liquid for the preserve. This make-up liquid can also be present in concentrated form and be diluted appropriately by further addition of water.

Alternatively to the inventive sweetener acesulfame-K, use can be made of other salts of acesulfamic acid, and also of the free acid itself. A possible preparation of acesulfame-K is, for example, the SO₃ process, which is described in EP-A-0 155 634. By varying the neutralization base, various acesulfame salts can be prepared.

Fruit varieties which are suitable are all varieties which can be processed to preserves, for example pears, peaches, cherries, but also citrus fruits, including mandarins, oranges, and also tropical fruits such as pineapples, mango, lychee and various berries. The fruit varieties can be used individually or in combination as a fruit cocktail or fruit mixture.

The processing conditions of the preserved fruit correspond to the production processes customary for comparable sugared products. This comprises first washing and if appropriate comminution of the fruits, then the addition of the sweetened make-up solution. Then heating is performed preferably in the closed package which can consist of glass, metal or plastic, to ensure the keeping quality of the fruit. The temperatures and heating times required for this can vary within wide ranges depending on the size and package and also processes used.

According to the invention, the sweeteners in preserved fruits are expediently used in mixing ratios of acesulfame-K/sucralose of 75/25% by weight up to 100/0% by weight, preferably in amounts of 75/25% by weight up to 95/5% by weight, and particularly preferably in amounts of 80/20% by weight up to 90/10% by weight (in each case always based on the total mass of the sweetener mixture).

As weight fraction of the inventive mixture of the initial weight of the total preserved fruit, depending on the desired sweetness intensity in the end product, preferably 0.005% by weight to 0.1% by weight is used, particularly preferably 0.015% by weight to 0.065% by weight.

Furthermore, in inventive preserved fruits, in addition to high-intensity sweeteners, various types of sugar (caloric sweeteners) can be present, for example sucrose, glucose, fructose in differing amounts. Since the natural sugar content in preserved fruits is dependent on the mixing ratio of the fruit to the make-up solution and also on the sugar content of the fruits, which is subjected to great variations depending on the fruit variety, season or region of cultivation, the content of caloric sweeteners can vary within broad limits. Added sugars can also be present in addition to the high-intensity sweeteners.

Furthermore, use can be made of small amounts of other sweeteners, for example cyclamate, saccharin, NHDC or others for flavor rounding and intensification of a defined aroma impression in the case of particular fruit varieties or fruit mixtures. The amounts required of these substances are in the range of up to 0.06% by weight, based on the total end product, depending on the taste intensity of the added substance.

Likewise, other ingredients can be added to the preserved fruits in concentrations known to those skilled in the art, for example acids (inter alia citric acid) for pH adjustment, antioxidants (such as ascorbic acid) to prevent browning reactions, thickeners to adapt the viscosity of the make-up solution or else dyes or aroma substances. Depending on additive and purpose, the customary concentration in use can vary around 0.01 to 1% by weight in the entire product.

The invention further relates to a process for the partial or complete sugar replacement in preserved fruits. In this case a portion up to the entire amount of the customarily added sugar in the preserved fruit is replaced by the inventive acesulfame-K/sucralose mixture.

The invention will be described in more detail below on the basis of examples.

### COMPARATIVE EXAMPLE

Preserved Pears Having Differing Acesulfame-K/Sucralose Ratios

Preserved pears were produced in accordance with the recipes specified in table 1. For this the pears were first peeled, chopped and treated with ascorbic acid solution (0.5% by weight) to prevent browning. The fruit was covered with hot make-up solution at 90° C. and then heated for a further 10 min at 90° C. in closed vessels. After cooling, the preserved fruit were stored for a plurality of weeks at room temperature (no controlled conditions) thereafter described in sensory terms by experienced panelists.

TABLE 1

| | Mixing ratios acesulfame-K to | | |
|---|---|---|---|
| | sucralose (sweetness distribution) | | |
| | 20/80 | 50/50 | Sugar |
| Pears | 100 g | 100 g | 100 g |
| Make-up | 100 ml | 100 ml | 100 ml |
| solution | | | |
| consisting of: | | | |
| acesulfame-K | 0.02 g/100 ml | 0.05 g/100 ml | — |
| sucralose | 0.032 g/ | 0.02 g/100 ml | — |
| | 100 ml | | |
| sugar | — | — | 27 g/100 ml |
| ascorbic acid | 0.1 g/100 ml | 0.1 g/100 ml | 0.1 g/100 ml |
| Taste | little pear taste, | little pear aroma, | sweet pear, |
| description | sweetness intensity | sweetness intensity | round, full |
| | corresponds to the | ok, long-persisting | sweetness |
| | comparison sugar, | sweet aftertaste | |
| | but long-persisting | | |
| | sweetness, | | |
| | licorice-like, sweet | | |
| | aftertaste | | |

(Note:
Analytically detectable concentrations of added sweeteners in the end product are significantly lower, since complete concentration exchange between fruit and solution takes place. In the table, concentrations of sweeteners are reported in relation to the make-up solution)

As the results show, none of the recipes tested fully achieved the taste qualities of sugar. The sweetness profile deviates from sugar, this also adversely influences the expression of the fruit aroma.

### EXAMPLE 1

Preserved pears were produced in a similar manner to the comparative example, but the recipes according to table 2 were used.

TABLE 2

| | Mixing ratios acesulfame-K to | | |
|---|---|---|---|
| | sucralose (sweetness distribution) | | |
| | 80/20 | 90/10 | Sugar |
| Pears | 100 g | 100 g | 100 g |
| Make-up | 100 ml | 100 ml | 100 ml |
| solution | | | |
| consisting of: | | | |
| acesulfame-K | 0.066 g/ | 0.0743 g/ | — |
| | 100 ml | 100 ml | |
| sucralose | 0.007 g/100 ml | 0.0035 g/ | — |
| | | 100 ml | |
| sugar | — | — | 17 g/100 ml |
| ascorbic acid | 0.1 g/100 ml | 0.1 g/100 ml | 0.1 g/100 ml |
| Taste | typical pear aroma, | typical pear aroma, | typical of |
| description | same sweetness | rapid onset of | pears, |
| | intensity, | sweetness, very | round |
| | sweetness onset | sugar-like, no off- | sweetness, |
| | as sugar, | taste | pleasant |
| | persistent | | sweetness |
| | sweetness | | intensity |

As may be seen, surprisingly better results were achieved with the novel mixing ratios. The sweetness profile of the mixtures 80/20 and 90/10 correspond to the sweetness profile of sugar. Also, both sugar-free variants corresponded to the sugared ones with respect to fruitiness.

### EXAMPLE 2

Preserved Pears Sweetened With Acesulfame-K and Sucralose Can No Longer be Differentiated From Sugar

In a similar manner to the comparative example, preserved pears were produced, table 3 shows the concentrations used.

TABLE 3

| | Acesulfame-K/ | |
|---|---|---|
| | sucralose | |
| | 80/20 (sweetness | |
| | ratio) | Sugar |
| Pears | 100 g | 100 g |
| Make-up solution | 100 ml | 100 ml |
| consisting of: | | |
| acesulfame-K | 0.066 g/100 ml | — |
| sucralose | 0.007 g/100 ml | — |
| sugar | — | 17 g/100 ml |
| ascorbic acid | 0.1 g/100 ml | 0.1 g/100 ml |

These samples were tested by 12 people in a triangle test. In this test, three samples, coded and in random sequence, were served to each tester; of the samples two were the same and one different. The different sample had to be identified. Only 4 of the testers correctly reported the different sample. Statistically, this does not represent a significant difference, since the probability that such a result would be obtained by chance is virtually 93%. The samples, therefore, cannot be separated from one another.

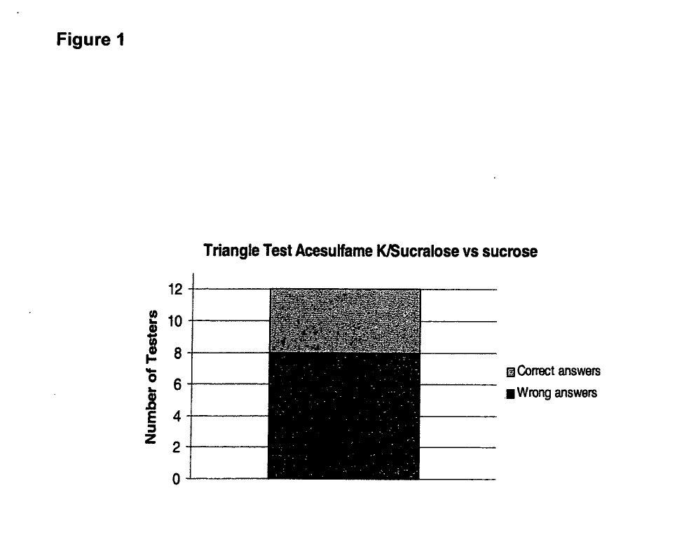

FIG. 1 illustrates the results.

### EXAMPLE 3

Preserved Pears Containing Acesulfame-K and Sucralose are Preferred to Comparable Products Containing Saccharin/Cyclamate

In a similar manner to the comparative example, preserved pears were produced and tasted, table 4 gives the concentrations used.

TABLE 4

| | Acesulfame-K/ | |
|---|---|---|
| | sucralose | |
| | 80/20 (sweetness | Saccharin/ |
| | ratio) | cyclamate |
| Pears | 100 g | 100 g |
| Make-up solution | 100 ml | 100 ml |
| consisting of: | | |
| acesulfame-K | 0.066 g/100 ml | — |
| saccharin | — | 0.012 g/100 ml |
| sucralose | 0.007 g/100 ml | — |
| cyclamate | — | 0.112 g/100 ml |
| ascorbic acid | 0.1 g/100 ml | 0.1 g/100 ml |
| Taste description | Marked pear aroma, | Flat aroma |
| | same sweetness | late-onset sweetness, |
| | intensity, sweetness | metallic off-taste, bitter |
| | onset as sugar, | aftertaste |
| | persistent sweetness, | |
| | no off-taste | |

### Conclusion

Using the inventive sweetener combination, various consumer expectations can be met considerably better than before. These are in detail:

no sugar addition necessary, thus reduced calories of the preserved fruits;

especially very good taste with respect to sweetness and fruit aroma;

long storage stability, taste remaining the same over the entire storage period.

1. A sweetener mixture consisting of acesulfame-K and sucralose in the weight ratio ≧75/25 to 100:0.

2. The mixture as claimed in claim 1, wherein the weight ratio of acesulfame-K to sucralose is between 75/25 and 95/5.

3. The mixture as claimed in claim 1 which additionally comprises one or more sweeteners selected from the group consisting of: cyclamate, saccharin and NHDC.

4. A preserved fruit comprising fruit and a sweetener mixture consisting of acesulfame-K and sucralose.

5. The preserved fruit as claimed in claim 4, wherein the weight fraction of the sweetener mixture of the weight of the total preserved fruit is 0.005% by weight to 0.1% by weight.

6. The preserved fruit as claimed in claim 4, wherein the fruit is in a container made of metal, glass or plastic.

7. The preserved fruit as claimed in claim 4, wherein the fruit is selected from one or more fruit varieties selected from the group consisting of pome fruit, stone fruit, berry fruit, tropical fruits, citrus fruits or wild fruits.

8. A process for sweetening preserved fruits, which comprises using the sweeteners acesulfame-K and sucralose.

9. A process for reducing the sugar content in preserved fruits, which comprises replacing a portion, or all, of the sugar which is added to the preserved fruit by a sweetener mixture consisting of acesulfame-K and sucralose.

10. A process for sweetening preserved fruits comprising adding a sweetener mixture consisting of acesulfame-K and sucralose.

11. Make-up solutions comprising a sweetener mixture consisting of acesulfame-K and sucralose.

12. A solution comprising a mixture as claimed in claim 1 and water.

13. The preserved fruit as claimed in claim 7, wherein the fruit comprises at least one of pineapple, apple, pear, peach, mandarin, and cherries.
